(19) United States
(12) Patent Application Publication
(10) Pub. No.: US 2002/0076373 A1
(43) Pub. Date: Jun. 20, 2002

(54) Use of lithium in NOx adsorbers for improved low temperature performance

(76) Inventors: Michel Molinier, Broken Arrow, OK (US); Owen Bailey, Claremore, OK (US)

Correspondence Address: Vicent A. Cichosz, DELPHI TECHNOLOGIES, INC., 1450 West Long Lake, Troy, MI, 48007, US

(21) Appl. No.: 09/741,674

(22) Filed: Dec. 19, 2000

(51) Int. Cl. G01N 21/75

(52) U.S. Cl. 423/239.1; 436/167

(57) ABSTRACT

Described herein is a NOₓ adsorber that reduces the amount of NOx in the exhaust stream of a lean-burn internal combustion engine. The adsorber incorporates a small amount of lithium along with a catalyst, an alkali material, and a support material. The lithium acts to facilitate the reduction of absorbed NOₓ, thereby lowering NOₓ concentrations in the exhaust gas.

### TECHNICAL FIELD

The present disclosure relates to nitrogen oxide adsorption materials used in exhaust systems of internal combustion engines.

### BACKGROUND

It is well known in the art to use catalyst compositions, including those commonly referred to as three-way conversion catalysts (“TWC catalysts”) to treat the exhaust gases of internal combustion engines. Such catalysts, containing precious metals like platinum, palladium, and rhodium, have been found to both successfully promote the oxidation of unburned hydrocarbons (HC) and carbon monoxide (CO), and promote the reduction of nitrogen oxides (NOₓ) in exhaust gas.

Fuel economy and global carbon dioxide (CO₂) emissions concerns have made it desirable to operate engines under lean-burn conditions to realize a benefit in fuel economy. When lean-burn conditions are employed, three way catalysts are efficient in oxidizing the unburned hydrocarbons and carbon monoxides, but are inefficient in the reduction of nitrogen oxides.

One approach for treating nitrogen oxides in exhaust gases of engines operating under lean-burn conditions has been to incorporate NOₓ adsorbers in exhaust lines along with three way catalysts. Conventional exhaust systems contemplate any number of configurations, including for example, use of NOₓ adsorbers in the same canister along with three-way catalysts, or use of a NOₓ adsorber in a separate canister upstream of a three-way catalyst, among others. For example, U.S. Pat. No. 5,727,385 to Hepburn, and U.S. Pat. No. 5,609,022 to Cho, which are herein incorporated by reference in their entirety, disclose compositions for a NOₓ adsorber.

Conventional adsorbers generally comprise a catalytic metal and one or more other materials which function together to reduce NOₓ. The catalyst typically is platinum, palladium, and/or rhodium. The catalyst is loaded on a porous support, and their combination is commonly known as “washcoat.” The catalytic material in the adsorber acts first to oxidize NO to NO₂. NO₂ then reacts with the alkali and alkaline earth materials to form stable nitrate salts. In a rich environment, the nitrate is thermodynamically unstable, and the stored NOₓ is released for catalysis, whereupon NOₓ is reduced to N₂ gas.

Conventional NOₓ adsorbers are limited in their capacity to reduce the stored NOₓ at low operating temperatures. At low temperatures, the ability of a NOₓ adsorber to reduce the stored nitrates is limited by several factors: the kinetics of adsorption, the efficiency of release, and the temperature of catalytic reduction. The adsorption and release limitations are somewhat mitigated by the lower NOₓ emissions and space velocities typically encountered at lower operating temperature. Enhancing the trapping capacity of the adsorber will also reduce the effect of the above limitations.

Despite efforts to maintain effectiveness at low operating temperatures, however, conventional adsorbers have suffered from undesirably high concentrations of released NOₓ that have not been reduced to molecular nitrogen before release from the converter.

What is needed in the art is a NOₓ adsorber capable of efficiently reducing NOₓ in lean-burn, low temperature conditions.

### SUMMARY

The above-described and other disadvantages of the prior art are overcome by the NOₓ adsorber. The NOₓ adsorber comprises: a substrate; and a composite material disposed on the substrate, the composite material comprising a catalyst, lithium, a support material, and a second material selected from the group consisting of alkali materials, alkaline earth materials other than lithium, and combinations comprising at least one of the foregoing second materials, wherein the lithium is less than about 5% by weight of the composite material.

Also described is a method of reducing the level of NOₓ in an internal combustion engine exhaust, comprising exposing the exhaust to a NOₓ adsorber during a lean cycle, trapping the NOₓ in the absorber, and reducing the NOₓ during a rich cycle, wherein the NOₓ adsorber comprises a substrate and a composite material disposed on the substrate, the composite material comprising a catalyst, lithium, a support material, and a second material selected from the group consisting of alkali materials, alkaline earth materials other than lithium, and combinations comprising at least one of the foregoing second materials, wherein the lithium is less than about 5% by weight of the composite material

### BRIEF DESCRIPTION OF THE DRAWINGS

Referring now to the figures, which are meant to be exemplary, not limiting.

FIG. 1 is a graphical representation of NOₓ conversion over time at 200° C., for a NOₓ adsorber comprising barium and potassium (NOₓ conversion of 11.2%).

FIG. 2 is a graphical representation of NOₓ conversion over time at 200°0 C. for one embodiment of a NOₓ adsorber comprising lithium (NOₓ conversion of 13.9%).

FIG. 3 is a graphical representation of NOₓ concentration over time for a NOₓ adsorber lacking lithium.

FIG. 4 is a graphical representation of NOₓ concentration over time for one embodiment of a NOₓ adsorber comprising lithium.

FIG. 5 is a graphical representation of NOₓ concentration over time for one embodiment of a NOₓ adsorber where the lithium to precious metal weight ratio is 0.5.

FIG. 6 is a graphical representation of NOₓ concentration over time for one embodiment of a NOₓ adsorber where the lithium to precious metal weight ratio is 1.5.

FIG. 7 is a graphical representation of hydrocarbon conversion over temperature for 4 embodiments of NOₓ adsorbers (line 71, Ba and Li; line 72, Ba and Na; line 73, Ba and K; and line 74, Ba and Cs) where all components are present in the same quantity except the type of alkali metal varies depending on the embodiment.

### DESCRIPTION OF THE PREFERRED EMBODIMENT

The NOₓ adsorber described herein employs a combination of lithium and alkali material and/or alkaline earth material plus a catalyst to effectuate the low temperature reduction of NOₓ to molecular nitrogen. The described composition, which can be used in combination with any conventional support and substrates, can be employed to decrease NOₓ emissions produced by internal combustion engines.

The NOₓ adsorber comprises a catalyst, an alkali material, lithium, a support material, and a substrate. The support material can be any material that is suitable for use in high temperature environments. Together, the catalyst, the support material, alkali material, and lithium form a composite material, which is commonly known in the art as a “washcoat.” The adsorber can be affixed to any part of an exhaust system suitable to effectuate NOₓ reduction.

As applied to the substrate, the composite material is loaded with sufficient alkali material to trap NOₓ in sufficient quantities and sufficient catalyst to efficiently reduce NOₓ. Specifically, the composite material can have a loading of, based upon the total weight of the composite material: about 0.2 to about 5 weight percent (wt %) of catalyst, about 2 to about 30 wt % of an alkali and/or alkaline earth material, and about 0.05 to about 5 wt % lithium; with about 0.5 to about 2 wt % catalyst, about 5 to about 15 wt % alkali and/or alkaline earth material, and about 0.1 to about 2 wt % lithium, preferably employed, and about 0.2 to about 1 wt % lithium especially preferred, with the particular loading selected based on the composite material used. The remainder of the washcoat is composed of the support materials described further. The ratio of precious metal to lithium is, in one embodiment, preferably about 1 or less. Lithium has been demonstrated to improve low temperature performance when the lithium to precious metal weight ratio is about 0.2 to about 1, but low temperature performance of the NOₓ adsorber is impaired when the lithium to precious metal weight ratio is greater than 1.5.

The catalyst comprises metals including, platinum, rhodium, palladium, ruthenium, iridium, gold, osmium, copper, nickel, cobalt, chromium, iron, manganese, and rare earth metals, and the like, as well as alloys and mixtures comprising at least one of the foregoing metals, and other conventional NOₓ catalysts. Where the catalyst is a combination of platinum with one or more other metals, the other metals, e.g., palladium, rhodium and the like, are typically present in an amount less than the platinum. More particularly, with a platinum/palladium combination, the catalyst can comprise up to about 85 weight percent (wt %) platinum and up to about 45 wt % palladium (or other metal), with about 55 wt % to about 80 wt % platinum and about 20 wt % to about 45 wt % palladium preferred, and about 55 wt % to about 75 wt % platinum and about 25 wt % to about 45 wt % palladium more preferred. With a platinum/rhodium combination, the precious metal material can comprise up to about 95 wt % platinum and up to about 30 wt % rhodium, with about 70 wt % to about 85 wt % platinum and about 15 wt % to about 30 wt % rhodium preferred; and about 70 wt % to about 80 wt % platinum and about 20 wt % to about 30 wt % rhodium especially preferred.

The alkali/alkaline earth material can comprise any alkali metal, alkaline earth metal, and compounds thereof except for lithium, such as sodium, potassium, cesium, rubidium, barium, magnesium, calcium, strontium and combinations comprising at least one of the foregoing, with barium, strontium, and magnesium preferred.

The catalyst, alkali/alkaline earth material, and lithium are loaded onto a suitable support material. Support materials include those materials suitable for use in environments such as those found in low temperature exhaust streams (around 200°0 C. and higher, typically up to about 1,000° C.). Such materials are preferably porous and comprise high surface area materials like alumina, gamma-alumina, delta-alumina, zeolite, zirconia, theta-alumina, cerium oxide (ceria), magnesium oxide, titania, silica, and combinations comprising at least one of these materials, among others. Desirably, the support material has a surface area up to or exceeding about 300 square meters per gram (m²/g).

For practical incorporation of the composite material (catalyst, alkali/alkaline earth material, support material, and lithium), into internal combustion engine exhaust systems, the composite material will typically be deposited on a chemically stable and thermally insulating substrate. Particularly useful substrates, as are commonly used for support material deposition include cordierite, mullite, silicon carbide, refractory oxides, alkali zirconium phosphates (NZP), and metallic materials, among others, and combinations comprising at least one of the foregoing substrates. The substrate may be formed in any size or shape, such as is required by the physical dimensions of the designed exhaust system. Similarly, the internal configuration of the substrate may be any known or commonly employed configuration. Substrates are typically formed as monolithic honeycomb structures, corrugated foils, layered materials, or spun fibers, among other configurations.

The composite material may be applied to the substrate as a mixture or in sequential steps in a manner which would be readily apparent to those skilled in the art of catalyst manufacture. For example, the support material can be first applied to the substrate followed by drying and calcination. The catalyst, alkali/alkaline earth material, and lithium can then be deposited on or within the support material by any suitable manner, such as by impregnation techniques well known to those skilled in the art. According to such techniques, the catalyst, alkali/alkaline earth material, and lithium, individually or together, would be dissolved as soluble precursors (e.g., as a salt-like potassium nitrate) in an aqueous or organic solvent which is then impregnated into the support material. Preferably, the catalyst is impregnated prior to the alkali/alkaline earth material and the lithium.

The alkali/alkaline earth material, lithium, and catalyst precursors can also be dissolved together in a common solution and impregnated into the support material in a single step. Suitable catalyst precursor solutions are aqueous solutions which facilitate efficient chemisorption of the catalyst onto the support material. Some suitable precursor solutions for a platinum catalyst, for example, include platinum nitrate solution, platinum chloride solution, and similar materials and combinations thereof, with platinum nitrate solution being preferred.

Other suitable techniques for application of the catalyst, lithium, and alkali/alkaline earth to the supporting material and the substrate include painting, dipping, imbibing, impregnation, and slurry deposition, among others. Deposition techniques are well known in the art and selection of any number of techniques and materials can be made to suit the particular materials and circumstances. After deposition, oven drying is performed.

Alternatively, the catalyst can be deposited on the composite material prior to application of the composite material to the substrate. This entails mixing of the support material, alkaline material, lithium, and catalyst prior to deposition and calcination on the support material.

After the composite material has been applied to the substrate, the NOₓ adsorber is placed into the exhaust stream of an internal combustion engine in any convenient location, and can be situated within other converters or within its own compartment in the exhaust stream. The internal combustion engine in which the adsorber is disposed can be any lean-burn internal combustion engine, such as a lean-burn diesel or gasoline engine.

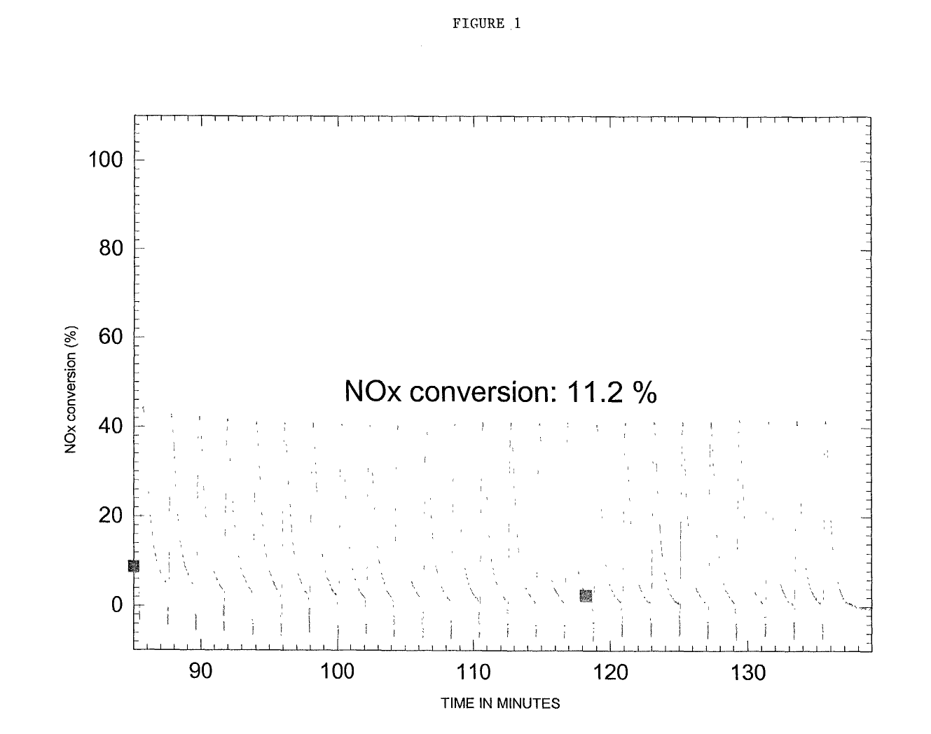

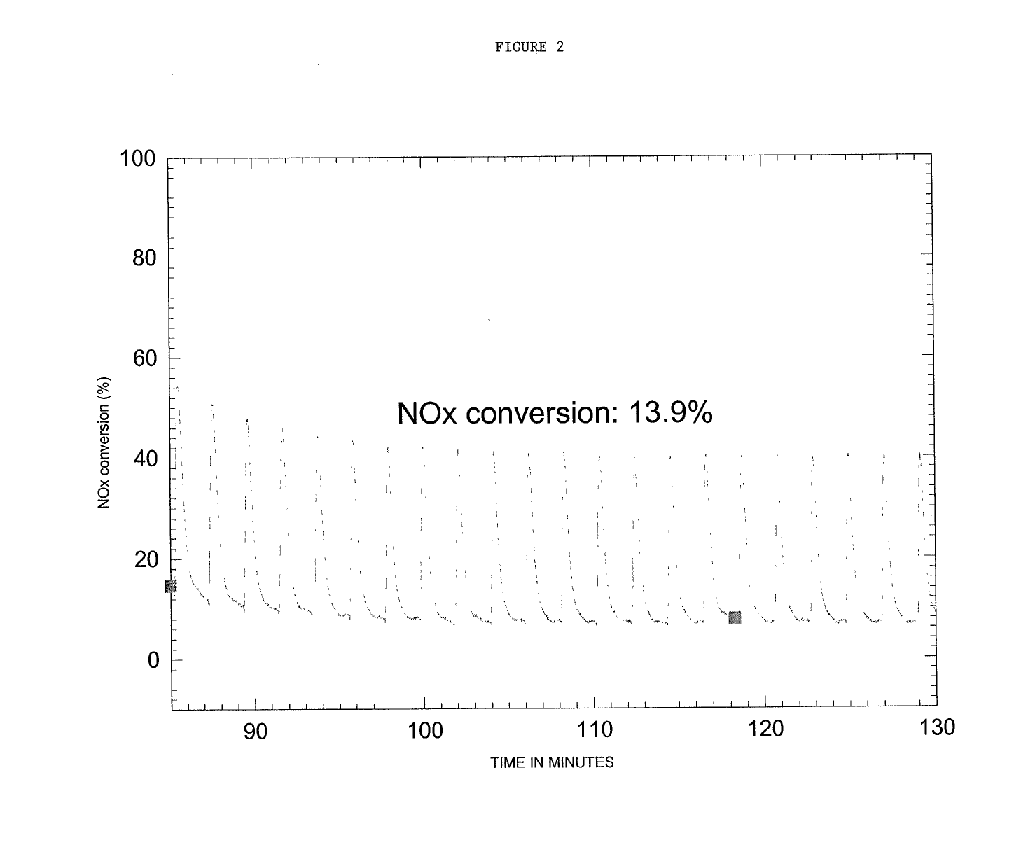

FIGS. 1-7 are plots showing examples of the use of NOₓ adsorbers to reduce NOₓ emissions in an exhaust gas. FIGS. 1 and 2 are plots of NOₓ conversion over time (minutes) in a synthetic gas stream at 200°0 C. FIG. 1 shows NOₓ conversion for a NOₓ adsorber comprising a support material loaded with a catalyst, an alkali/alkaline earth material (includes potassium, not lithium). FIG. 2 shows NOₓ conversion for a NOₓ adsorber comprising a support material loaded with a catalyst, an alkali/alkaline earth material, and lithium, wherein the molar concentration of lithium is equivalent to the molar concentration of potassium used for the adsorber of FIG. 1.

The repetitive fluctuation of the conversion percentage is caused by the switching of the exhaust stream from rich to lean and back to rich to enable proper reduction of the adsorbed NOₓ. It is clear from the results shown in FIG. 1 and FIG. 2, which show an average increase of NOₓ reduction for the adsorber with lithium, that the inclusion of lithium increases the overall NOₓ reduction capacity of the adsorber. Further, whereas FIG. 1 shows the NOₓ conversion percentage dropping to near zero for each fluctuation in the adsorber lacking lithium, FIG. 2 shows that a minimum of about 10% of NOₓ is converted for each fluctuation with the adsorber comprising lithium. The benefit of lithium is, however, somewhat masked by the high space velocity applied in this particular experiment.

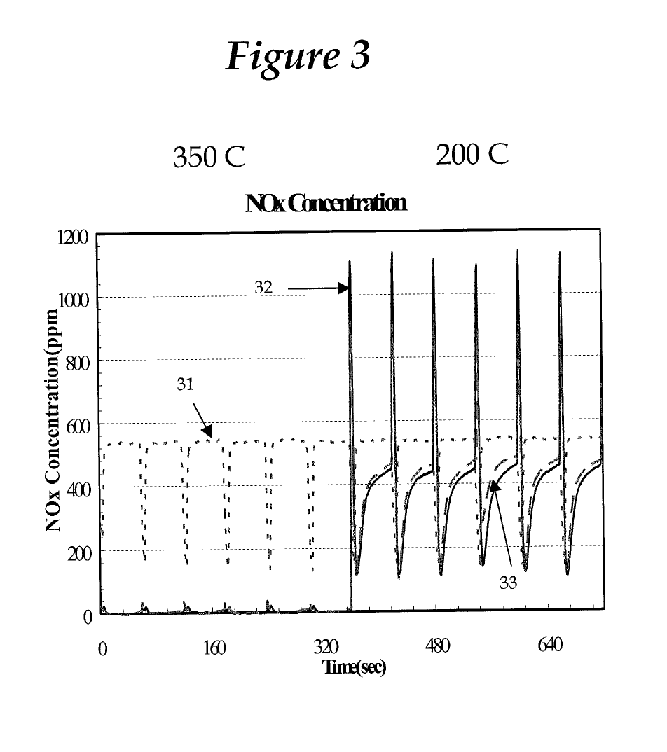

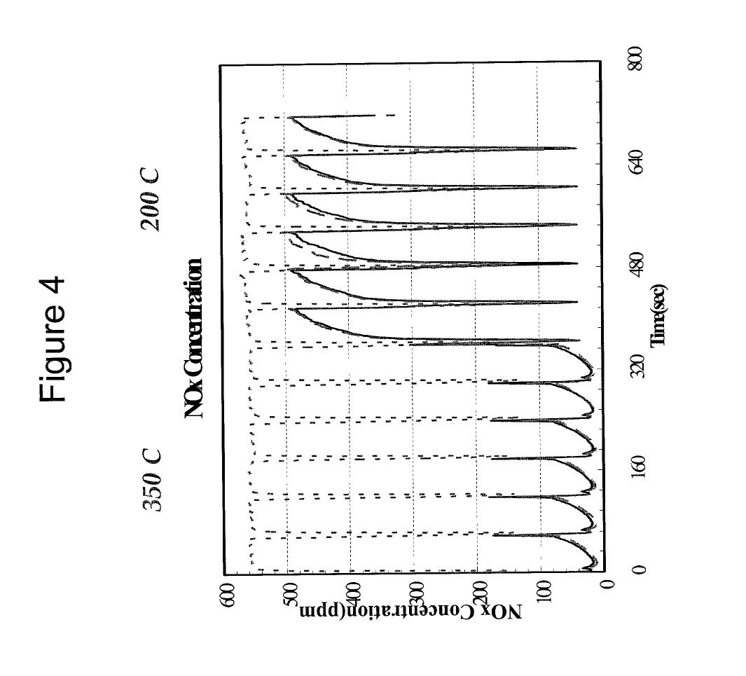

FIGS. 3 and 4 are plots of NOₓ concentration over time in a diesel exhaust stream at 200° C. after aging for 16 hours (hrs) at 700° C. in air and 10% water. FIG. 3 represents NOₓ concentration for an adsorber with potassium, as used for FIG. 1, while FIG. 4 represents NOₓ concentration for an adsorber with lithium, as used for FIG. 2. In these figures, line 31 represents the amount of NOₓ exiting the engine and entering the adsorber. FIGS. 3 and 4 clearly show that the adsorber with lithium reduces more NOₓ and produces a final exhaust gas with a lower NOₓ concentration than does the adsorber without lithium; the catalyst of FIG. 3 had a 15% conversion efficiency at 200°0 C., while the catalyst of FIG. 4 had a 25% conversion efficiency at 200°0 C. Basically, spikes 32, which represent released but unconverted NOₓ, exist in FIG. 3 and essentially not in FIG. 4. The released NOₓ in FIG. 4 is converted. The main benefit at 200°0 C. is obtained through the disappearing of the spikes corresponding to released but unconverted NOₓ; those spikes are very high in the case of the potassium formulation, while almost non-existent in the case of the lithium formulation.

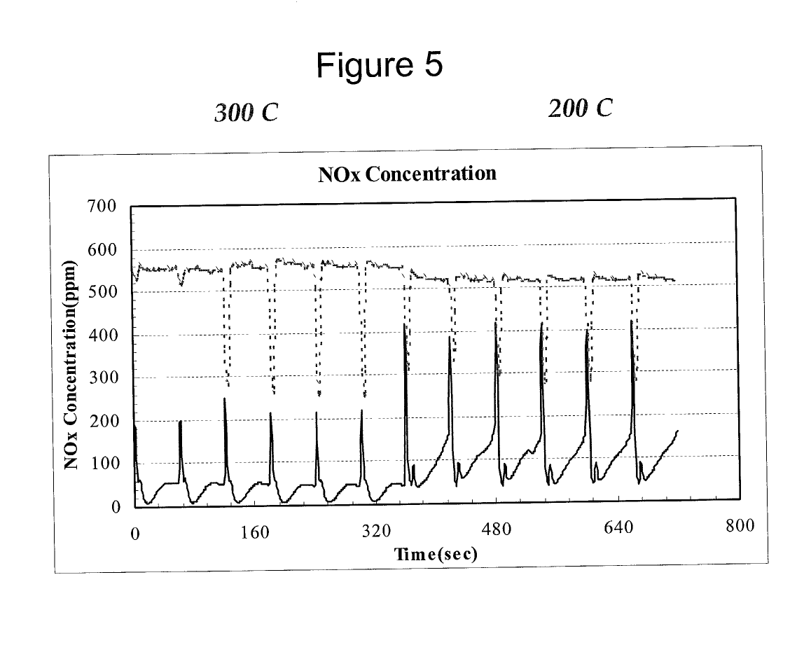

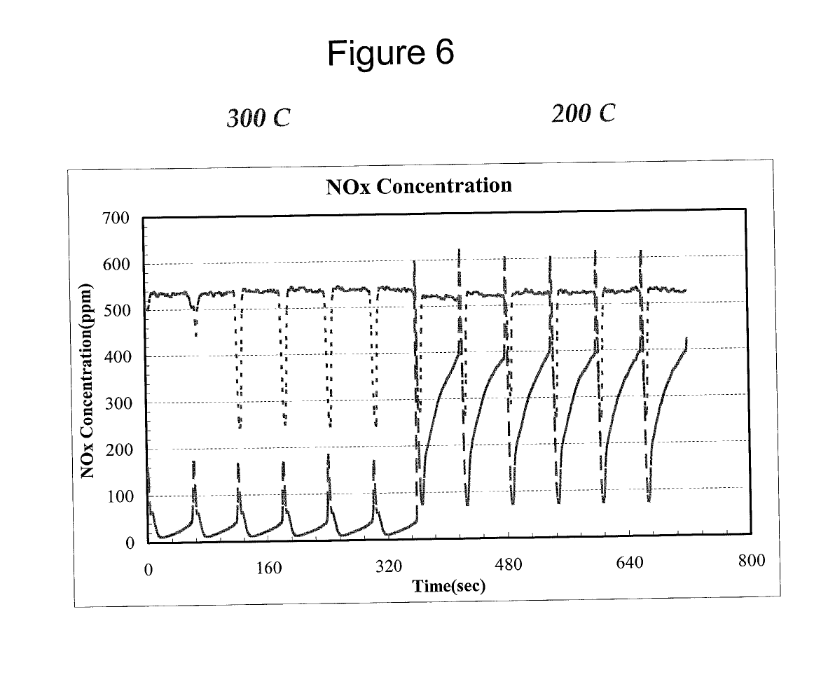

FIGS. 5 and 6 are plots of NOₓ concentration over time in a diesel exhaust stream at 300° C. and 200°0 C. In FIG. 5, with a lithium to precious metal ratio of 0.5, very high conversion is achieved at 200°0 C. This conversion is divided by two when the lithium to precious metal ratio is 1.5 (FIG. 6). Basically, at a space velocity (S.V.) of 32,000 hr⁻¹, modulation (lean-rich) of 54 seconds (s)/6 s, the NOₓ conversion at 300° C. was 93%, with a 78% conversion at 200°0 C. for the catalyst of FIG. 5, while the catalyst of FIG. 6 had a 94% conversion at 300° C. with a 41% conversion at 200°0 C. (The area between the dotted lines (NOₓ entering the adsorber) and the solid lines (NOₓ exiting the adsorbers) represents the amount of NOₓ converted.)

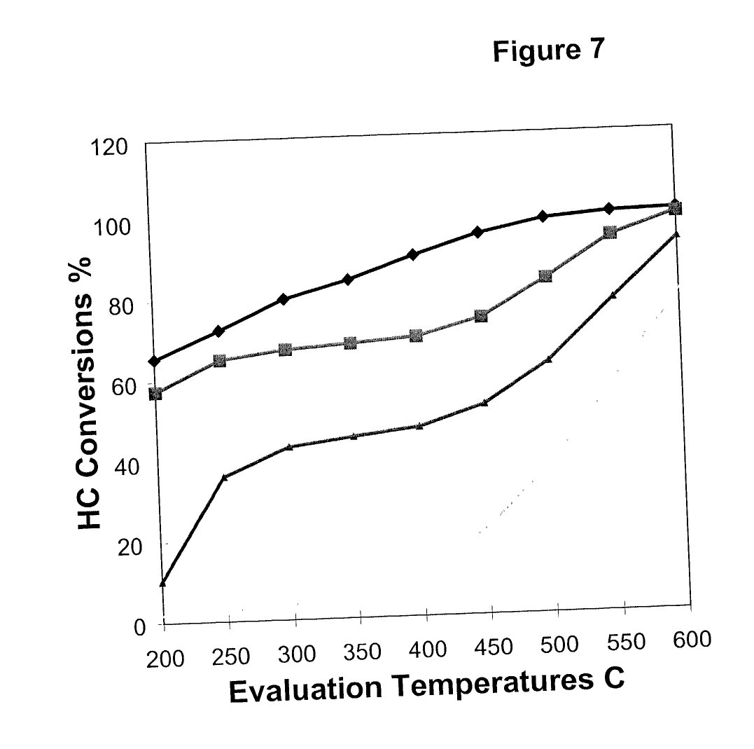

The NOₓ adsorber described above provides increased NOₓ reduction potential without increasing the size of the adsorber. Additionally, lithium also improves the reduction of hydrocarbon over a large temperature window compared to potassium; line 71 represents barium and lithium, line 72 represents barium and sodium, line 73 represents barium and potassium, and line 74 represents barium and cesium. (See FIG. 7)

As is evident from the above data, the incorporation of lithium into a NOₓ adsorber improves slightly NOₓ adsorption (even at low temperatures when the weight ratio of lithium to precious metal is below 1.5), and the main advantage is that the adsorber reduces a greater percentage of the NOₓ, resulting in a more consistent conversion of the NOₓ (i.e., as the system switches from rich to lean and back, large quantities of NOₓ are not released as compared to conventional systems (see FIGS. 3 and 4)).

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A NOₓ adsorber, comprising:
a substrate; and
a composite material disposed on the substrate, the composite material comprising lithium, a support material, a catalyst, and a second material selected 5 from the group consisting of alkali materials, alkaline earth materials other than lithium, and combinations comprising at least one of the foregoing second materials, wherein the lithium is less than about 5% by weight of the composite material.

2. The NOₓ adsorber of claim 1, wherein the support material is selected from the group consisting of alumina, gamma-alumina, delta-alumina, theta-alumina, zeolite, zirconia, ceria, magnesium oxide, titania, silica, and mixtures comprising at least one of the foregoing catalysts.

3. The NOₓ adsorber of claim 1, wherein the catalyst is selected from the group consisting of platinum, rhodium, palladium, ruthenium, iridium, osmium, copper, nickel, cobalt, chromium, iron, manganese, rare earth metals, and alloys and mixtures comprising at least one of the foregoing catalysts.

4. The NOₓ adsorber of claim 1, wherein the second material is selected from the group consisting of sodium, potassium, cesium, rubidium, barium, magnesium, calcium, strontium, and alloys and mixtures comprising at least one of the foregoing second materials.

5. The NOₓ adsorber of claim 1, wherein the substrate is selected from the group consisting of cordierite, metal, silicon carbide, refractory oxide, NZP, mullite, and mixtures comprising at least one of the foregoing substrates.

6. The NOₓ adsorber of claim 1, further comprising a three-way catalyst component positioned downstream of the adsorber or as part of the adsorber.

7. The NOₓ adsorber of claim 1, wherein the alkali material is about 2 to about 30 weight percent of the composite material, the catalyst is about 0.2 to about 5 weight percent of the composite material, and the lithium is about 0.1 to about 2 weight percent of the composite material.

8. The NOₓ adsorber of claim 7, wherein the alkali material is about 5 to about 15 weight percent of the composite material, the catalyst is about 0.5 to about 2 weight percent of the composite material, and the lithium is about 0.2 to about 0.7 weight percent of the composite material.

9. The NOₓ adsorber of claim 1, wherein the catalyst comprises a precious metal, and wherein the composite material has a lithium to precious metal weight ratio of less than about 1.5.

10. The NOₓ adsorber of claim 9, wherein the lithium to precious metal weight ratio is about 0.2 to about 1.

11. A method for reducing the level of NOₓ in an internal combustion engine exhaust gas, comprising:
exposing the exhaust gas to a NOₓ adsorber during a lean cycle, wherein the NOₓ adsorber comprises a substrate and a composite material disposed on the substrate, the composite material comprising: a catalyst, lithium, a support material, and a second material selected from the group consisting of alkali materials, alkaline earth materials other than lithium, and combinations comprising at least one of the foregoing second materials, wherein the lithium is less than about 5% by weight of the composite material;
trapping the NOₓ in the absorber; and,
reducing the NOₓ during a rich cycle.

12. The method of claim 11, wherein the support material is selected from the group consisting of alumina, gamma-alumina, delta-alumina, theta-alumina, zeolite, zirconia, ceria, magnesium oxide, titania, silica, and mixtures comprising at least one of the foregoing catalysts.

13. The method of claim 11, wherein the catalyst is selected from the group consisting of platinum, rhodium, palladium, ruthenium, iridium, osmium, copper, nickel, cobalt, chromium, iron, manganese, rare earth metals, and alloys and mixtures comprising at least one of the foregoing catalysts.

14. The method of claim 11, wherein the second material is selected from the group consisting of sodium, potassium, cesium, rubidium, barium, magnesium, calcium, strontium, and alloys and mixtures comprising at least one of the foregoing second materials.

15. The method of claim 11, wherein the substrate is selected from the group consisting of cordierite, metal, silicon carbide, refractory oxide, NZP, mullite, and mixtures comprising at least one of the foregoing substrates.

16. The method of claim 11, further comprising disposing a three-way catalyst downstream of the adsorber.

17. The method of claim 16, wherein the three-way catalyst is part of the adsorber.

18. The method of claim 11, wherein the composite material comprises, based upon the total weight of the composite material, about 2 to about 30 wt % of the second material, about 0.2 to about 5 wt % of the catalyst, and about 0.05 to about 5 wt % of the lithium.

19. The method of claim 18, wherein the composite material comprises, based upon the total weight of the composite material, about 5 to about 15 wt % of the second material, about 0.5 to about 2 wt % of the catalyst, and about 0.1 to about 2 wt % of the lithium.

20. The method of claim 19, wherein the composite material comprises, based upon the total weight of the composite material, about 0.2 to about 1 wt % of lithium.

21. The method of claim 11, wherein the catalyst comprises a precious metal, and wherein the composite material has a lithium to precious metal weight ratio of less than about 1.5.

22. The method of claim 21, wherein the precious metal weight ratio is about 0.2 to about 1.
